(19) United States
(12) Patent Application Publication
(10) Pub. No.: US 2012/0036398 A1
(43) Pub. Date: Feb. 9, 2012

(54) MULTIPLE CORE DATA PROCESSOR WITH USAGE MONITORING

(75) Inventors: William C. Moyer, Dripping Springs, TX (US); David R. Bearden, Austin, TX (US); Ravindraraj Ramaraju, Round Rock, TX (US)

(73) Assignee: FREESCALE SEMICONDUCTOR, INC., Austin, TX (US)

(21) Appl. No.: 13/272,725

(22) Filed: Oct. 13, 2011

Related U.S. Application Data
(63) Continuation-in-part of application No. 12/765,534, filed on Apr. 22, 2010.

(51) Int. Cl. G06F 11/14; G06F 9/312

(52) U.S. Cl. 714/48; 712/220; 714/E11.112; 712/E09.033

(57) ABSTRACT

A data processor with a plurality of processor cores. Accumulated usage information of each of the plurality of processor cores is stored in a storage device within the data processor, wherein the accumulated usage information is indicative of accumulated usage of each processor core of the plurality of processor cores. The processor uses the accumulated usage information in selecting processor cores to perform processor operations.

### RELATED CASES

This application is a continuation-in-part of U.S. application Ser. No. 12/765,534, having a filing date of Apr. 22, 2010, and having a common assignee, all of which is hereby incorporated by reference in its entirety.

### BACKGROUND OF THE INVENTION

1. Field of the Invention

This invention relates to multi core data processors and more specifically to usage monitoring in multi core data processors.

2. Description of the Related Art

Multi core data processors are data processors that include two or more processor cores. Because data processors are implemented on integrated circuits, the cores of a processor have a finite operating life based on the number of operations performed. As the accumulated number of operations performed increases, the integrated circuit may be more readily susceptible to dielectric breakdown, electro migration, and Negative Bias Temperature Instability. Furthermore, the temperature, operating frequency, and operating voltage under which a processor operation is performed may affect the longevity of the data processor. Typically, the higher the average operating temperature and/or operating voltage, the shorter the longevity (useful life) of the processor.

Some system manufactures who implement data processors may have longevity requirements where a data processor should be able to cumulatively operate at a particular operating condition (e.g. at a particular temperature, voltage, frequency range) for a particular number of hours.

What is needed is an improved system for allowing flexible use of a data processor.

### BRIEF DESCRIPTION OF THE DRAWINGS

The present invention may be better understood, and its numerous objects, features, and advantages made apparent to those skilled in the art by referencing the accompanying drawings.

FIG. 1 is a block diagram of a data processing system according to one embodiment of the present invention.

FIG. 2 is a table of data stored in a data processing system according to one embodiment of the present invention.

FIG. 3 is a table of data stored in a data processing system according to one embodiment of the present invention.

FIG. 4 is a flow chart of an operation of a data processor according to one embodiment of the present invention.

FIG. 5 is a table of data stored in a data processing system according to one embodiment of the present invention.

FIG. 6 is a flow chart of an operation of a data processor according to one embodiment of the present invention.

FIG. 7 is a flow chart of an operation of a data processor according to one embodiment of the present invention.

FIG. 8 is a flow chart of an operation of a data processor according to one embodiment of the present invention.

FIG. 9 is a flow chart of an operation of a data processor according to one embodiment of the present invention.

FIG. 10 is a flow chart of an operation of a data processor according to one embodiment of the present invention.

FIG. 11 is a flow chart of an operation of a data processor according to one embodiment of the present invention.

FIG. 12 is a flow chart of an operation of a data processor according to one embodiment of the present invention.

FIG. 13 is a flow chart of an operation of a data processor according to one embodiment of the present invention.

FIG. 14 is a flow chart of an operation of a data processor according to one embodiment of the present invention.

FIG. 15 is a flow chart of an operation of a data processor according to one embodiment of the present invention.

FIG. 16 is a flow chart of an operation of a data processor according to one embodiment of the present invention.

The use of the same reference symbols in different drawings indicates identical items unless otherwise noted. The Figures are not necessarily drawn to scale.

### DETAILED DESCRIPTION

The following sets forth a detailed description of a mode for carrying out the invention. The description is intended to be illustrative of the invention and should not be taken to be limiting.

Embodiments described relate to a multi core data processor that monitors and tracks the accumulated usage of each core. In some examples, the usage can be tracked at different operating conditions such as at different operating voltages, temperatures, operating frequencies, and at different thermal cycling conditions. In other embodiments, the measure of usage can be altered by operating conditions that affect the operating life of the integrated circuit. In one example, the accumulated usage of each core can be used in assigning data processor operations to the cores so as to balance core usage or to ensure reliable operation near the end of the operating life of the data processor. It can also be used to alert a system user when the end of life of a part is near.

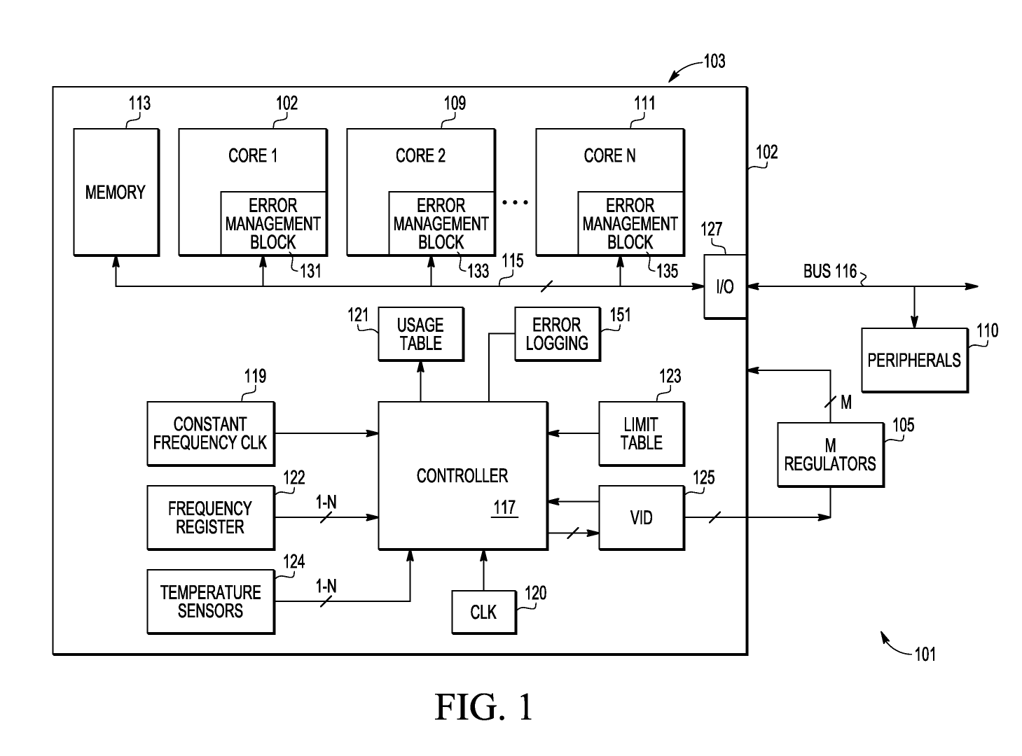

FIG. 1 is a block diagram of a data processing system 101. Data processing system 101 includes a multi core data processor 103, which in one embodiment is implemented in an integrated circuit 102. In other embodiments, data processor 103 may be implemented in multiple integrated circuits. In the embodiment shown, processor 103 is a multi core data processor that includes processor cores 107, 109, and 111, but may include a different number of processor cores in other embodiments. A processor core includes an execution unit for performing processing operations as per executable code. Each core of processor 103 is of a particular data processing architecture type such as e.g. Power PC, x86, SPARC, MIPS, or ARM architecture. Each core also is of a particular processor configuration such as e.g. a general purpose processor, a digital signal processor, an applications specific processor, or a network packet inspection processor. In one embodiment, the cores have identical configurations and architectures, but in other embodiments, the cores have different configurations and architectures from each other. For example, one of the cores may be a digital signal processor and the other cores may be general purpose processors of a different architecture.

Processor 103 includes a system memory 113 that is operably coupled to the cores via a processor bus 115 (or other type of system interconnect in other embodiments). Processor 103 also includes I/O circuitry 127 coupled to bus 115 for coupling data processor 103 to peripheral devices 110 of data processing system 101 via a peripheral bus 116. Examples of peripheral devices 110 include a memory (e.g. hard disk drive, RAM, ROM, Flash), key board, mouse, speaker, microphone, display, and bridge. In one embodiment, at least some devices or a portion some devices may be located on the same integrated circuit 102 as processor 103.

Processor 103 includes a clock circuit 120 for providing clock signals to the circuitry of processor 103 including to cores 107, 109, and 111, and memory 113. In one embodiment, clock circuit 120 provides an independently controllable clock signal to each processor core to control the operating frequency of that core (the clock signal lines to each core are not shown in FIG. 1). Processor 103 may have other configurations in other embodiments including other circuits such as e.g. a cache (not shown).

System 101 also includes multiple voltage regulators 105 for providing regulated operating voltages to circuitry of data processor 103 including to the cores 107, 109, 111, and memory 113. The voltages provided by the regulators are controlled by VID values from VID registers 125. In one embodiment, each processor core receives a separate regulated voltage that is independently controlled by a separate VID value to enable the operating voltage of each core to be individually adjusted. In other embodiments, the operating voltage to multiple cores can be controlled by one VID value.

In the embodiment shown, processor includes a controller 117 for controlling the assignment of processor operations to each core. A processor operation is an operation performed by one or more processors executing a set of instructions. In the embodiment shown, controller 117 is implemented by circuitry separate from cores 107, 109, and 111. However, in some embodiments, at least portions of controller 117 maybe implemented by a software program running on one of cores 107, 109, and 111. Controller 117 evaluates the programs being run on data processor 103 and assigns the operations of those programs to be performed by a particular core or cores. In one embodiment, processes or threads of execution may be assigned by the operating system or other software to one or more specific cores. In addition, hardware multithreading or multiprocessing control may be implemented within controller 117 which directs the execution of different sets of operations to one or more selected processors.

In the embodiment shown, controller 117 also monitors the accumulated usage of each core over the lifetime of integrated circuit 102. The accumulated usage of a core refers to a cumulative amount of usage of the core during its lifetime. In one embodiment, the accumulated usage is measured in terms of time in performing operations, but it other embodiments, it may be measured with respect to other parameters such as the number of tasks performed or the number of instructions executed by the core.

Processor 103 includes a usage table 121 that stores the accumulated usage information for each core. In one embodiment, table 121 is implemented in a non volatile memory on integrated circuit 102 (“on chip”). However, table 121 may be implemented in other ways in other embodiments. For example, the usage information could be stored in on-chip RAM during the operation of system 101 and down loaded to an off-chip non volatile memory (e.g. hard disk drive, battery-backed RAM, flash memory, etc.) when the processor is not being used.

In the embodiment shown, processor 103 includes a constant frequency clock generator 119 for providing a constant frequency clock signal to controller 117 that controller 117 uses to calculate time to add to the accumulated usage information of each core. In one embodiment, controller 117 determines that the core is being used by determining that the core's clock is running, by interrogating a status indicator, or by determining that the core is in one or more active states of operation (e.g. by reading a particular register associated with the core). In one embodiment, controller 117 measures the time that it's being used by the clock signal from clock generator 119. That amount of time is then added to the accumulated usage information for that core stored in usage table 121. In one embodiment, generator 119 may include an input coupled to an off-chip crystal (not shown), but other techniques for generating a constant frequency clock signal may be used in other embodiments. Also in other embodiments, a different method of calculating elapsed time may be employed by controller 117 to determine usage time. In some embodiments, a real time clock provided from off-chip can be used to measure the total elapsed time as function of wall clock time.

In the embodiment shown, processor 103 includes a limit table 123 for storing the lifetime limits of the processor core. A lifetime limit is the total amount of usage that a core is expected to reliably perform during its lifetime. In one embodiment, limit table 123 is stored in an on chip non volatile memory but may be implemented in other ways in other embodiments. For example, the lifetime limits may be provided by programmable logic or a hardware logic table, or may be stored in an off chip memory.

In one embodiment, controller 117 uses the accumulated usage information for each core in assigning the processor operations to each core. In one embodiment, controller 117 assigns the processor operations to the cores with the least amount of accumulated usage time in order to balance the usage times among the cores.

In one embodiment, controller 117 includes the ability to adjust the accumulated usage value or record separate usage values for a core operating at specific operating conditions. Due to various factors, operating at an elevated higher operating frequency, temperature, or operating voltage for a particular time reduces the useful life of a core by a greater amount than when operating at a relatively lower operating frequency, temperature, or operating voltage. Accordingly, in the embodiment shown, data processor 103 includes circuitry and systems for determining the operating condition of a core for a use of a core. For example, processor 103 includes frequency registers 122 for providing the operating frequency of each core. In one embodiment, the operating frequency of each core is written to registers 122 by the operating system of data processor 103. In one embodiment, clock circuit 120 uses the information in registers 122 in providing the clock signals to each core. Processor 103 includes temperature sensors 124 for providing an indication of the operating temperature of each core. In one embodiment, each core includes its own temperature sensor, however in other embodiments, one temperature sensor could be used to provide an indication for the temperature of each core or at least some of the cores. In the embodiment shown, controller 117 provides the VID values to register 125 to control the operating voltage for each core. However, in other embodiments, other circuitry may control the operating voltages where controller 117 would receive an indication of the VID values (which indicate operating voltage) from register 125. The operation condition of the cores may be determined by other ways in other embodiments.

In the embodiment shown, the usage monitoring of each core is performed by controller 117. In some embodiments, controller 117 may include a usage monitor module (not shown) for monitoring individual core usage and a separate assignment module (not shown) for assigning processor operations to the cores. These modules may be implemented in different circuitry and/or with different code. In such embodiments, the assignment module may utilize the accumulated usage information generated by the usage monitor module in distributing processor operations to the different cores.

In the embodiment of FIG. 1, each core (102, 109, and 111) includes an error management block (131, 133, and 135) that performs error detection and/or correction on the data generated or used by the core during a processor operation. In some embodiments, these blocks compare data generated by a “canary” processor operation with expectant data to provide an indication of processor reliability. In other embodiments, processor 103 includes a block (not shown) coupled to bus 115 that performs the detection/correction operations.

Also in some embodiments, processor 103 is capable of performing error detection logging of the errors generated or detected by each core. In one example, controller 117 performs error detection logging of the errors in a table 151. In other embodiments, processor 103 includes a dedicated controller for performing error detection logging. This controller is operably coupled to error management blocks 131, 133, and 135 or other error detection circuitry to receive an indication of when a particular core generates an error so as to record the event. In other embodiments, the error detection logging could be tracked and maintained by the operating system or other programs (which are executed on the cores).

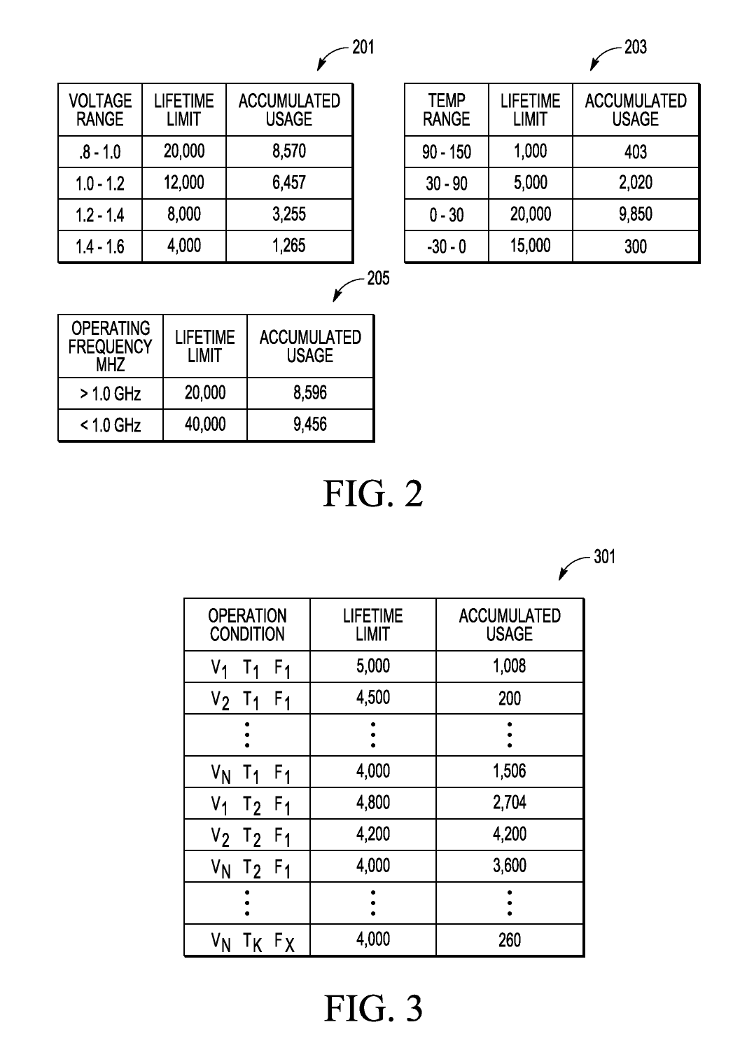

FIG. 2 illustrates the types of accumulated usage information that may be stored in usage table 121 in one embodiment of the present invention. Table 201 shows, for a particular core, the accumulated usage information (under the heading “accumulated usage”) for each operating voltage range. The values in the accumulated usage column represent the amount of time (in hours in one embodiment) that a core has operated with an operating voltage at that specified voltage range. For example, the particular core associated with the values shown in table 201 has operated with an operating voltage in the range of 0.8-1.0 volts for 8570 hours. The core has operated with an operating voltage in the range of 1.0 to 1.2 volts for 6,457 hours. The core has operated with an operating voltage in the range of 1.2 to 1.4 volts for 3,255 hours. The core has operated with an operating voltage in the range of 1.4-1.6 volts for 1265 hours. Accordingly with table 201, controller 117 can track the amount of time that a core operates with an operating voltage in a particular voltage range. In other embodiments, accumulated usage may be recorded in other units of time e.g. such as minutes, seconds or a number of constant frequency clock cycles.

Table 203 records the amount of time (under the heading “accumulated usage”) that a core operates at a particular temperature range (in Celsius) and table 205 records the amount of time that a core operates at a particular operating frequency range. In one embodiment, usage table 121 would include three such tables for each core. However, in other embodiments, usage information for a lesser or greater number of operating condition parameters may be monitored. For example, in one embodiment, a count of excessive thermal temperature cycles (a sudden change in operating temperature) that a core has been subject to may be stored.

In the embodiment of FIG. 2, each table (201, 203, and 205) includes a “Lifetime Limit” column that represents the expected amount of reliable operation of the core at that particular operating condition over the lifetime of the data processor. For example, in table 201, the core is expected to be able to operate for 20,000 hours with an operating voltage in the range of 0.8-1.0 volts.

Because of the stress of operating at higher operating frequencies, temperatures, and/or operating voltages, the lifetime limits as shown in FIG. 2 for the higher operating frequencies, temperatures, and operating voltages is less than for the lower values of these parameters. In the embodiment of FIG. 1, the lifetime limit information is store in table 123, however, in other embodiments, the accumulated usage and lifetime limit information may be stored in the same memory. The values given in tables 201, 203, and 205 are exemplary values for a particular core of a data processor according to one embodiment. The tables of other embodiments may include other values for accumulated usage and lifetime limit.

In one embodiment, controller 117 uses the data in tables 201, 203, and 205 for each core to assign processor operations to a particular core. For example, if a particular processor operation requires operating at a particular operating frequency (e.g. above 1 GHz), controller 117 may look for the processor core with the lowest amount of accumulated usage time at that particular operating frequency range and assign the processor operation to that core.

In other embodiments, it may be desirable for a particular core of a data processor to perform a particular processor operation. In one example, one core of a multi core processor may be identified as having the fastest performance. Prior to assigning a processor operation to that core, controller 117 would examine the accumulated usage column of that core at the particular desired operating frequency or voltage and determine whether that particular core has exceeded its lifetime of operation for that operating condition. If the lifetime limit has been exceeded, controller 117 would assign another core the processor operation.

In other embodiments, the accumulated usage may be one factor in assigning cores. For example, controller 117 may assign multiple cores to perform a processor operation based on both the lowest accumulated usage and thermal balancing of the cores on the integrated circuit. In one such example, the cores may be arranged in such a way that particular combinations of cores provide the lowest thermal output to avoid hot spots on the integrated circuit. The combination selected to perform the processor operation may be the combination with the lowest total accumulated usage, the combination having the core with the lowest accumulated usage, or the combination with the lowest value for the highest accumulated usage core of the combination.

In other embodiments, controller 117 may lower the operating voltage or reduce the operating frequency of a core (by providing a control signal to clock circuit 120) if the accumulated usage value at the desired operating voltage or frequency is over the lifetime limit. For example, if the desired operating voltage for a particular processor operation is 1.5 volts, but the accumulated usage value has exceed the lifetime limit at that range, controller 117 may drop the operating voltage (by adjusting the VID value) to a lower voltage. Also, if the temperature is at a range where the life time limit has been exceeded, then controller 117 may drop the operating voltage and/or frequency to reduce the operating temperature.

FIG. 3 shows another embodiment of a usage table according to the present invention. In the embodiment shown, each entry of table 301 represents an operating condition that is defined by three parameters (operating voltage (V), operating temperature (T), and operating Frequency (F). The entries in the operating condition table of “V1,” “V2”, and “VN” represent different operating voltage ranges, the entries “T1”, “T2,” and “TK” represent different operating temperature ranges, and the entries “F1” and “FX” represent different operating frequency ranges. Accordingly, each entry of the table is defined by a particular operating voltage range, a particular operating frequency range, and a particular temperature range. Each monitored combination of operating voltage range, operating frequency range, and temperature range has an entry in the table. The usage time and lifetime limit is recorded for each operating condition entry. A table similar to table 301 would be recorded for each core of data processor 103. In other embodiments, the operating conditions maybe defined by a greater or lesser number of operating condition parameters.

In one embodiment, controller 117 uses each table to assign processor operations among the cores to balance the accumulated usage totals for each core at a particular operating condition. Also, the operating condition of a processor core for performing processor operations may be adjusted based on the accumulated usage value verses the Lifetime Limit.

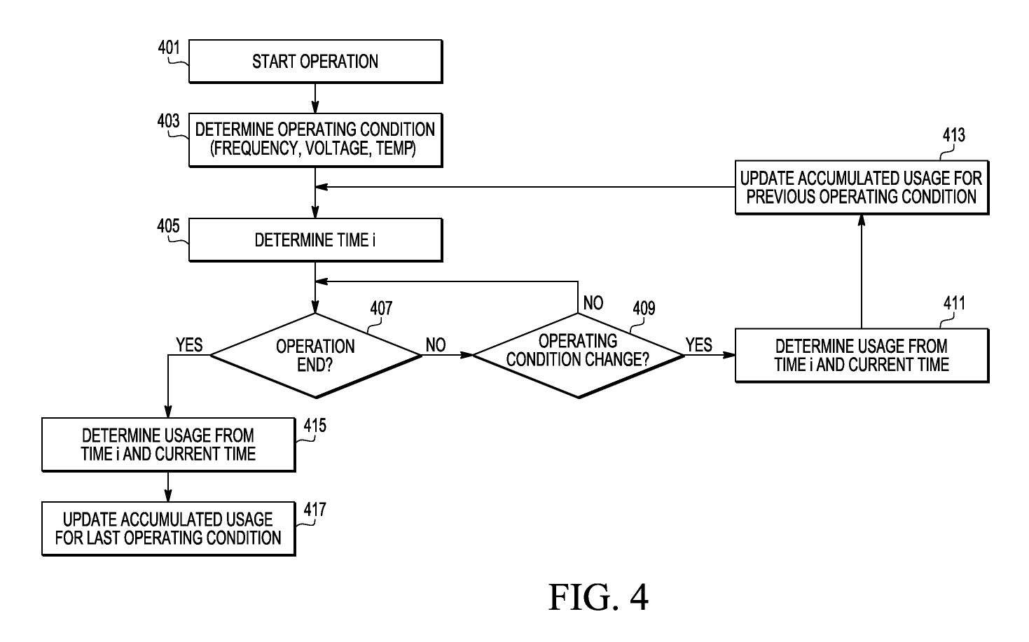

FIG. 4 shows a flow chart of an operation of a controller 117 in monitoring the accumulated usage of a core according to one embodiment of the present invention. The method is started at the start 401 of a processor operation by a processor core. In 403, the operating condition of the core is determined (e.g. measurements are made of the operating frequency, operating voltage, and temperature) and in operation 405, the time (time i) is determined at the start of the processor operation from the clock signal provided by the constant frequency clock generator 119. In decision block 407, a determination is made whether the processor operation has been completed by the core. If so, in operation 415 a usage time is determined by subtracting the current time (as indicated by the clock signal from clock generator circuit 119 at the end of the processor operation) from the time (time i) determined in operation 405. In operation 417, the accumulated usage value for the core for the particular operating condition measured in 403 is updated to reflect the usage time for the processor operation.

If in 407, the processor operation has not ended and the operating condition changes (e.g. a change in temperature, operating voltage, or operating frequency) as determined in decision block 409, then in 411, a usage time is determined by subtracting the time (time i) determined in operation 405 from the current time (the time at the change of the operating condition) as determined by the clock signal from clock generator 119. In 413, that usage time is added to the accumulated usage time for the operating condition determined in operation 403. After 413, the process flows back to operation 405 where the current time determined in 411 becomes time i. The process continues to monitor the core until the processor operation is finished or the operating condition changes for a second time. At which time, the accumulated usage for the operating condition resulting from the first change in operating condition is updated with the usage time since the first occurrence of 411. Thus, with the process in FIG. 4, usage time is tracked for a particular set of operating conditions.

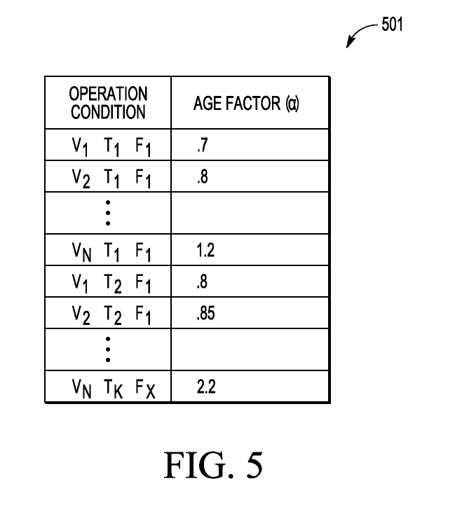

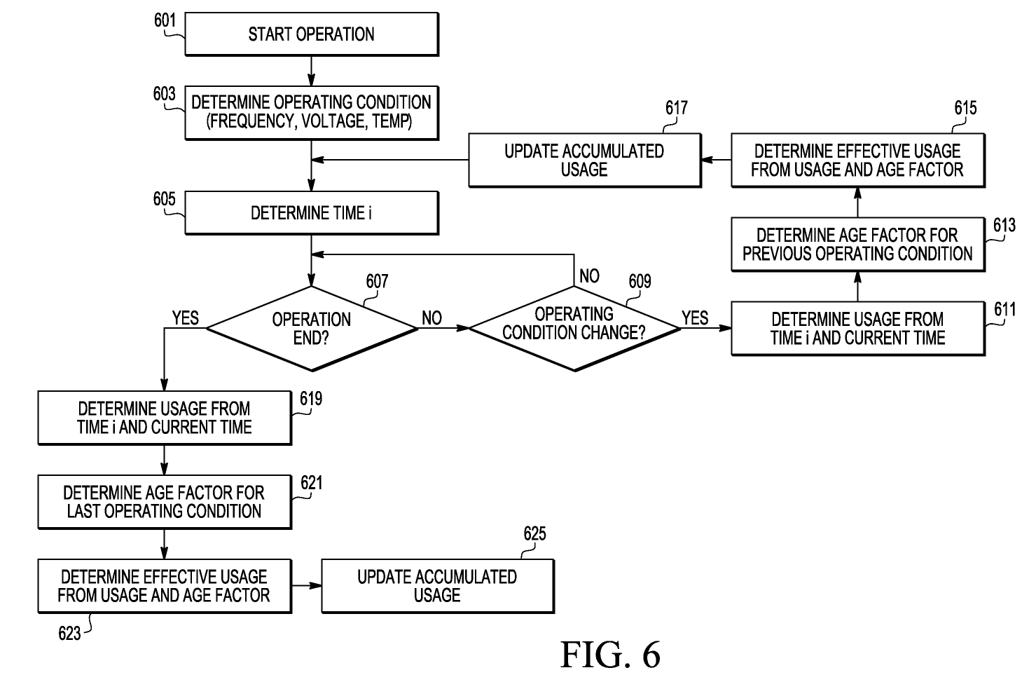

FIGS. 5 and 6 set forth a table and flow diagram respectively, for another embodiment for using monitored operating conditions in the tracking of accumulated usage of a processor core. In this embodiment, only one value for accumulated usage is stored for each core. The time for performing a processor operation by a core that is recorded for the accumulated usage time is altered or adjusted based on the measured operating condition during that time to reflect the severity of the operating condition at that time. For example, if a processor core operates for 5 hours at 70 degrees C., it is more detrimental to the operating life of the core than operating at 5 hours at 25 degrees C. Accordingly, with this embodiment, the measured operating time is increased to reflect the increased severity of the operating condition.

FIG. 5 shows a table listing an age factor associated with a particular operating condition that is defined by a particular voltage range (V), temperature range (T), and frequency range (F). The values V1, V2, and VN represent different operating voltage ranges, the values T1, T2, and TK represent different temperature ranges, the values F1 and FX represent different operating frequency ranges. The age factor value for that operating condition reflects the severity of that operating condition on an integrated circuit operation. For example, operating in operating conditions with relatively high temperature ranges (e.g. 50 C and higher) will more quickly reduce the operating life of an integrated circuit than when operating at lower temperatures. According, the age factor for operating conditions with higher temperature ranges are higher (e.g. above 1.0) than for operating conditions with lower temperature ranges. In one embodiment, table 501 is stored in usage table 121, however, other embodiments may store the information using other mechanisms.

FIG. 6 shows one embodiment of how controller 117 uses the age factor of a measured operating condition to update the accumulated usage for a core. In 601, a processor operation is started by a core. In 603, the operating condition (e.g. operating frequency, operating voltage, and operating temperature) of the core is determined and in 605, a time (time i) based on clock generator 119 is determined at the start of the processor operation. At decision block 607, a determination is made as to whether the processor operation is completed. If it has completed, in 619, the usage time is determined by subtracting time i (determined at 605) from the current time (the time when the processor operation is completed). At 621, an age factor is retrieved from the table based on the operating condition determined in 603. In 623, the usage time is multiplied by the age factor to derive an effective usage time. The accumulated usage time for that core is then updated with the effective usage time at 625.

If the processor operation has not ended in 607, then in response to a change in operating condition (e.g. temperature, operating voltage, or operating frequency) in decision 611, a usage time is determined from subtracting the time (time i) determined in 605 from the current time (the time that the operating condition changes). In 613, the age factor corresponding to the operating condition determined in 603 is multiplied by the usage time determined in 611 to derive an effective usage in 615. In 617, the accumulated usage for the core is updated with the effective use. In the second occurrence of 605, time i becomes the time at the change in operating condition (as determined in 611). The process continues until the operating condition changes as determined in 609 or the processor operation is complete (as determined in 607). The usage time is then calculated from the time at operation 613 to the time that the processor operation stops or the operating condition changes. The age factor is determined from the operating condition during that time and is used to adjust the usage time.

In other embodiments, an age factor may be implemented in other ways. For example, each operating condition parameter (e.g. temperature, operating voltage, and operating frequency) may have its own age factor, in which all three age factors would be used to determine effective usage time. In one such example, each age factor would be multiplied by the measured time. In one example of such an embodiment, each age factor would be obtained from a separate table and would correspond to a range of the measured corresponding operating condition parameter. In another embodiment, the age factor would be obtained from a formula using the measured operating condition value as the dependent variable in the formula and the age factor as the independent variable. In some embodiments, the total age factor may be reflective of a lesser number (e.g. 2 or 1) parameters e.g. just temperature.

In other embodiments, other operating condition parameters may monitored and used to adjust or calculate an accumulated usage. For example, the accumulated usage may be measured or adjusted for excessive thermal cycling of the core. Excessive thermal cycling is where the operating temperature changes by at least a predetermined amount during a predetermined period of time. If excessive thermal cycling is determined to occur during a period of time, that time can be recorded in a table. In some embodiments, the usage time representing the time during a processor operation that includes the thermal cycling is increased to reflect the occurrence of the excessive thermal cycle. In some embodiments, a predetermined time may be added to the accumulated usage upon the detection of an excessive thermal cycling event.

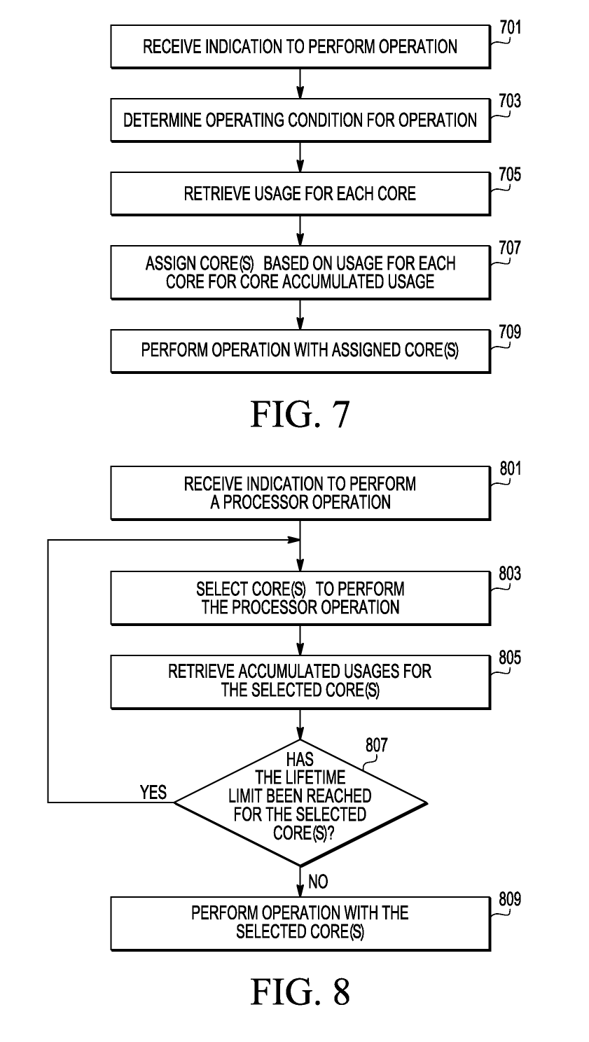

FIG. 7 sets forth a flow diagram showing the operation of controller 117 in using the accumulated usage information from each of the cores to assign processor tasks to a core or cores according to one embodiment of the present invention. In 701, controller 117 receives an indication of a processor operation to be performed. In one embodiment, this indication is provided by the operating system or other software monitor, or in other embodiments by an interrupt indicating the need for processing of information. In 703, controller determines the desired operating condition (e.g. operating frequency and operating voltage) for the processor operation. In one embodiment, the desired operating condition is based on the relative priority of the operation, or other measures of processing power required or desired to be used. In 705, the accumulated usage values for each core are obtained. In one embodiment, the usage values for the desire operating conditions are obtained (e.g. as in the embodiment of FIG. 3), whereas in the embodiment of FIGS. 5 and 6, the total accumulated usage values for each core are obtained. In 707, the core or cores are assigned to perform the processor operations based on the accumulated usage of each core to balance the accumulated usages among the cores. In 709, the processor operation is performed with the assigned cores.

FIG. 8 shows the operations of controller 117 in determining which cores to use to perform a processor operation according to another embodiment of the present invention. In this embodiment, other factors may be used to select a core or cores to perform a processor operation in addition to the accumulated usage of the cores. In addition, as described earlier, it may not be desirable to balance accumulated usage of the cores, and other selected metrics using the accumulated usage information for one or more cores may be used in determining which core(s) are used to perform the processor operation.

In action 801, controller 117 receives an indication to perform a processor operation. In 803, controller 117 selects a core or cores to perform the operation. In one embodiment, the selection in 803 is based on factors such as whether the core has been previously determined to be the most efficient or the fastest, or operates at the lowest temperature based on process variation during manufacture. In 805, controller 117 retrieves the accumulated usage values for the selected core or cores. In 807, if the accumulated usage has exceeded the lifetime limit for a selected core, then another core is chosen and its accumulated usage is evaluated to determine if it has reached its life time limit. If not, then the selected core performs the task in 809.

In some embodiments, if the accumulated usage of a core exceeds the lifetime limit, the system may be alerted that the processor core may in danger of failure. Also, the accumulated usage data may be used for other purposes, such as fault analysis of a part. Determining an allocated usage at different operating conditions for a core may enable an integrated circuit manufacturer to more accurately determine the cause of failure of a core.

In other embodiments, multiple “life time limit” values for each operating condition may be given for a core which each value having a different threshold. In some embodiments, in response to the accumulated usage value of a core reaching one of the lower threshold levels, controller 117 would reduce the operating voltage and/or frequency of any processor operations performed by the core. Thus, as the part ages and nears the end of its life, operating voltages and frequencies can be reduced to extend core life.

Also, in some embodiments, age factors according to some operating condition parameters may be used to adjust the accumulated usage values that are stored in a table corresponding to ranges of other operating condition values.

Providing a multi core processor that monitors accumulated usage of its cores may provide for a data processor that balances the work performed by each of the cores to extend the life of the integrated circuit which incorporates the multi core data processor. By balancing the loads, the chance of a premature failure of one of the cores is reduced. If load balance is not utilized, then the life time of a data processor is limited to the lifetime of any of the cores. Whereas with load balancing, the rated life of the data processor can be a greater than the rated lifetime of any one core.

Furthermore, by accounting for the severity of the operating conditions of a core during the performance of a processor operation, a more accurate estimate of the reduction of useful life of a core by the processor operation can be determined.

In one embodiment in a data processor including a plurality of processor cores, a method includes storing accumulated usage information for each of the plurality of processor cores in a storage device. The accumulated usage information for a processor core of the plurality of processor cores is indicative of accumulated usage of the processor core. The method also includes updating by the data processor accumulated usage information for a core of the plurality of processor cores in response to the data processor determining a use of the core.

In another embodiment, a data processor includes a plurality of processor cores for performing data processing operations and a storage device for storing accumulated usage information for each of the plurality of processor cores that is indicative of accumulated usage of the each of the plurality of processor cores. The data processor also includes a controller for determining usage of the plurality of processor cores. The controller updates accumulated usage information of a processor core of the plurality of processor cores in response to determining a use of the processor core.

In another embodiment in a multi core data processor, a method includes receiving an indication to perform a data processing operation and selecting at least one selected processor core of a plurality of cores of the data processor to perform the data processing operation. The selecting includes using accumulated usage information of at least one of the plurality of cores. Accumulated usage information of a processor core is indicative of accumulated usage of the processor core. The method includes performing the data processing operation by the at least one selected processor core.

In some embodiments, a core may be used after it has reached its lifetime limit of accumulated usage. For example, for non-critical processor operations, it may be desirable to use cores that have exceeded their lifetime limit so as to save other cores for operations that require reliability. Also, once a core has exceeded a lifetime limit, particular measures may be taken to ensure or check that the core is still functioning properly for continued use. For example, error detection may be enabled for cores that have exceeded a lifetime limit or other usage threshold. Also, cores may be paired with other cores to perform redundant operations for checking processor operations. Still in other embodiments, operations performed by cores exceeding a particular usage level may be checked by higher level programs of the operating system (or BIOS). This higher level checking may be performed by operations of other cores.

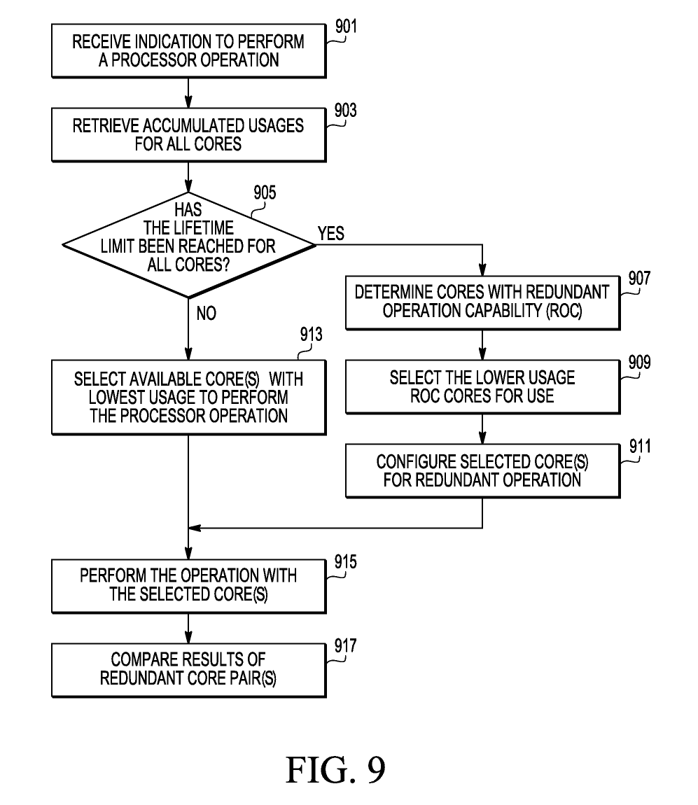

FIG. 9 sets forth a flow diagram showing how the accumulated usage information can be used to determine when to take measures to ensure data reliability when using a core that has exceeded its life time limit (either from an aggregate lifetime limit or at the particular operating condition). In this flow, when a core has exceed its lifetime limit (or some other predetermined threshold), the core is then paired with another core where each core performs the operation in parallel. The resulting data is then checked against each other to see if the same data was generated by both cores (indicating that the operation was performed successfully).

In FIG. 9, controller 117 receives an indication of a processor operation to be performed. In action 903, controller 117 retrieves the accumulated usage information for all cores. In 905, a determination is made of whether the lifetime limits of all cores have been met. If they have not, then in action 913, controller 117 selects the core or cores with the lowest accumulated usage to perform the processor operation. In some embodiments, those cores whose accumulated usage has exceeded their lifetime limit would not be available for selection in action 913. In action 915, the processor operation is performed by the selected core(s).

If in 905, the accumulated usage lifetime limits of all the cores have been reached, then in action 907, controller 117 determines which cores have redundant operation capability. In one embodiment, processor 103 includes a table or other circuitry (not shown) that stores an indication of whether the core can be configured for redundant operation.

In action 909, of the cores that can be used redundantly, the cores with the lowest accumulated usage are selected to perform the processor operations in a redundant configuration. In some embodiments, certain cores may only be redundantly operated with other specific cores. In some of those embodiments, the core with the lowest accumulated usage is selected and paired with the core with the lowest accumulated usage of the cores for which it can be paired. In other embodiments, the pair of cores with the lowest average accumulated usage is selected for performing the operation.

In action 911, the selected cores are configured for redundant operation wherein the same instructions are executed by both cores. In action 915, the operation is performed by the redundant core pair or pairs.

In action 917, the data generated by each core of a redundant core pair is compared against each other to determine if the results are the same (indicating that the operation was performed without error) or different (indicating that one of the cores generated an error. In one embodiment, controller 117 performs the compare operation, but this operation may be performed by other circuitry (e.g. by another controller or monitor logic of processor 103 or by other cores executing software) in other embodiments. Upon an error, the operation would be performed by two other redundant core pairs until a match in generated data is obtained.

In some embodiments, the operations are performed redundantly by 3 or more cores. With such an embodiment, the matching data generated by the majority of cores (or a specific threshold of cores) are used as the correct data. For example, if two of the three cores (or three of four cores) generated the same data, then that data would be considered the correct data.

As shown in FIG. 9, the useful life of a processor (that implements redundant operations based on accumulated usage) may be extended past the lifetime limits of its cores. With some embodiments, redundant operations are not enabled until all of the cores have reached a usage level where reliability may be an issue due to designed lifetime usage limits. Accordingly, when accumulated usage is well below the designed lifetime limits, the processor can save power in not performing the operations redundantly.

In some embodiments, when a core or cores exceed their useful life but are selected to perform a processor operation, controller 117 can modify (e.g. raise or lower) the operating voltage and/or frequency of the processor core in performing the operation. Thus, the operating voltages can be changed and frequencies can be reduced to extend core life, especially in some embodiments where the cores are to be operated past their lifetime limits.

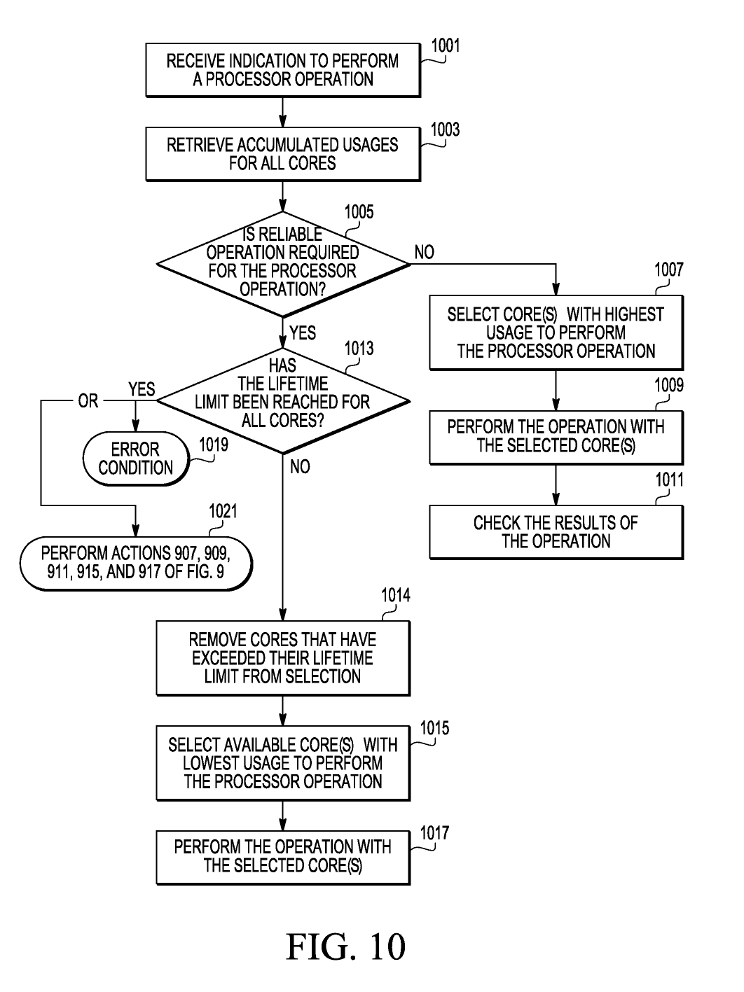

FIG. 10 sets forth a flow diagram showing how a determination of whether reliability is required of a processor operation along with accumulated usage can be used in assigning a core or cores to perform operations. In the embodiment of FIG. 10, a differentiation is made of whether the particular processor operation is one that requires reliability or not. If the operation requires reliability, then that operation is assigned to a processor core that has a low accumulated usage. If reliability is not required, then the operation can be performed by a processor core that has a high accumulated usage. Performing a critical operation with a processor core with a lower accumulated usage may provide for a greater chance that the operation will be performed correctly. Performing a non-critical operation with a processor core with a high accumulated usage allows for the other processors to be “saved” for operations requiring reliability. Hence, the other processor cores will not be “worn out” performing operations that do not require reliable operation.

In one example where a processor is used in an automobile, operations involving motor control and braking would require a high degree of reliability. Operations involving display of information and audio processing would require less reliability. For example, if a pixel of a display or if small segment of a song were not processed correctly, a driver may not notice the error. However, an error in motor operation or braking may cause severe problems.

In action 1001, controller 117 receives an indication of a processor operation to be performed. In action 1003, controller 117 retrieves the accumulated usage information for all cores. In 1005, a determination is made of whether the processor operation is one that requires reliability or not. In one embodiment, required reliability may be determined by the processor operation type, by a location in memory where the operation resides, or by the class of service or other characteristics of the application being executed.

If reliability is not required in 1005, then in action 1007, the core or cores with the highest accumulated usage are selected to perform the operations, which are then performed by the selected core or cores in action 1009. In the embodiment of FIG. 10, the results of the processor operation can be checked in action 1011 e.g. by the execution of a software routine in the operating system to determine if the operation was performed correctly or by other checking methods either implemented by additional hardware in processor 103, or by various software strategies. However, in some embodiments, checking action 1011 is not performed.

If reliability of the processor operation is required in 1005, then in 1013, a determination is made of whether the lifetime limits have been reached for all cores. If there are cores that have not reached their lifetime limits, then in action 1014, the cores that have reached their lifetime limits are removed from selection, and in action 1015, the core or cores are selected from the available cores based upon the lowest accumulated usage value. In action 1017, the processor operation is performed by the selected cores.

If in 1013 all of the cores have reached their lifetime limit, an error condition is generated in 1019 indicating that reliable processor operation cannot be guaranteed due to the accumulated usage of all of the cores being past their lifetime limit. In some embodiments, the processor operation may be performed redundantly by multiple cores (in action 1021) as described in actions 907, 909, 911, 915, and 917. In some embodiments, the operation is performed with redundant processor cores (actions 907, 909, 911, 915, and 917) and a warning message is generated regarding the accumulated usage of all cores being past their lifetime limit.

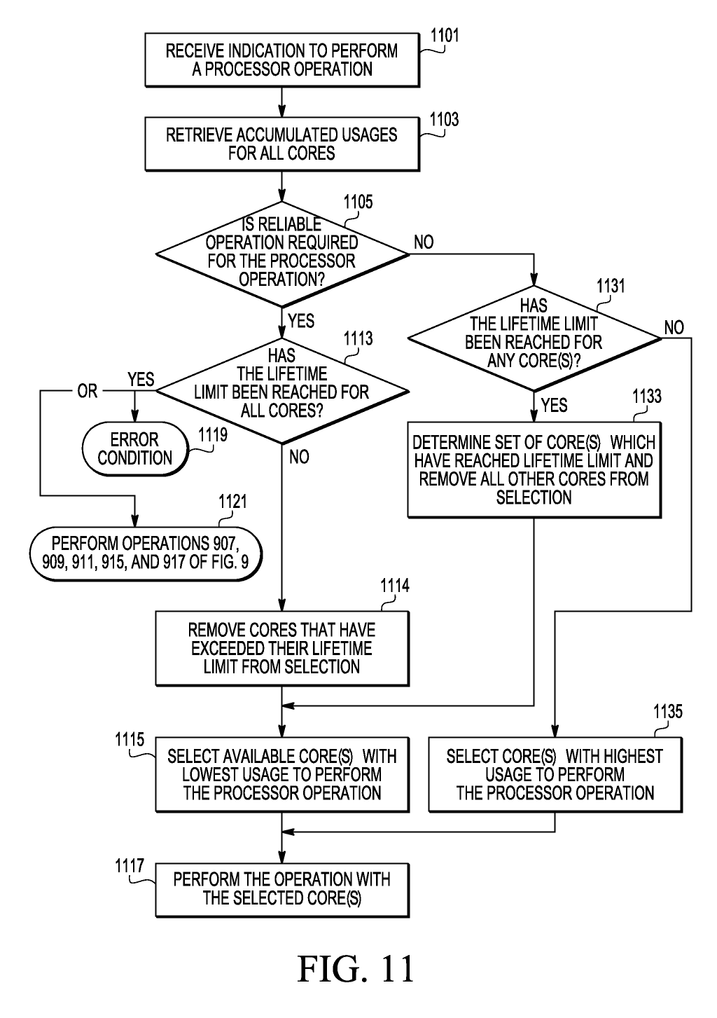

FIG. 11 represents a flow chart showing a modification of the process set forth in FIG. 10. The process of FIG. 11 differs from the process or FIG. 10 in that controller 117 assigns operations not requiring reliability to the cores with the highest accumulated usage until a core exceeds its lifetime limit. Once a core or cores exceeds its lifetime limit, the processor operations not requiring reliability are assigned to cores that have exceeded their lifetime limit based on the lowest usage of those cores. Hence, with the process of FIG. 11, some cores will incur higher wear with operations not requiring reliability until they reach their lifetime limit. Once they reach their lifetime limit, the operations not requiring liability are assigned to the cores based on which ones have the lowest accumulated usage. With this example, the operations not requiring reliability are performed by “worn out” cores with the lowest usage which increases the probability that that they will be performed correctly by such a core.

In FIG. 11, controller 117 receives an indication of a processor operation to be performed. In action 1103, controller 117 retrieves the accumulated usage information for all cores. In 1105, a determination is made of whether the processor operation is one that requires reliability or not. If reliability is not required in 1105, then in 1131, a determination is made whether the lifetime limit has been reached on any of the cores. If no in 1131, then in 1135, the core(s) with the highest usage are selected to perform the processor operation. If there are cores that have reached their lifetime limit as determined in 1131, then all other cores whose usage is below their lifetime limit are removed from selection in action 1133 and the remaining cores (that have exceeded their lifetime limit) with the lowest accumulated usage are selected in action 1115 to perform the operation in action 1117.

If reliability of the processor operation is required as determined in 1105, then in 1113, a determination is made whether the lifetime limit has been reached for all cores. If there are cores that have not reached their lifetime limit, then in action 1114, the cores that have reached their lifetime limit are removed from selection, and in action 1115, the available cores are selected based upon the lowest accumulated usage. In action 1117, the processor operation is performed by the selected cores.

If in 1113 all of the cores have reached their lifetime limit, an error condition is generated in action 1119 indicating that reliable processor operation cannot be guaranteed due to accumulated usage of all of the cores being past their lifetime limits. In some embodiments, the processor operation may be performed redundantly by multiple cores (in process 1121) as described in actions 907, 909, 911, 915, and 917. In some embodiments, the operation is performed with redundant processor cores and a warning message is generated regarding the accumulated usage of all cores being past their lifetime limits.

Some embodiments may include a usage threshold value where the cores are all evenly used up to a certain threshold value regardless of whether reliability is required or not. After all of the cores reach the threshold value, then non-reliable operations are performed by the cores with the highest accumulated usage. Thus, only a subset of cores is worn out by performing operations not requiring reliability. In this way, all processor operations are performed with a high degree of accuracy in the beginning. Only after a certain number of operations, does the system switch to wearing out a few cores for operations not requiring reliability to save the other cores for operations requiring reliability. Thus, a system implementing such an assignment methodology will operate at peak performance during the first few years of operation. However, if the system is maintained in service after its designed life, the system will still be able to perform operations requiring reliability with a higher probability of success in later years.

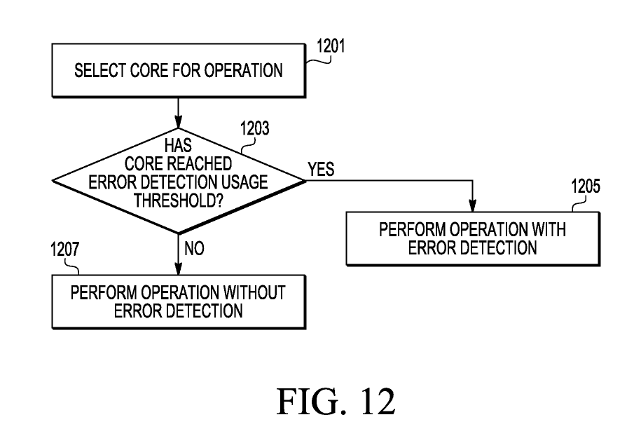

FIG. 12 shows a flow diagram of how accumulated usage can be used to determine when to implement “costly” error prevention measures due to the accumulated usage of a core increasing to a point where reliability of the core may be an issue. In FIG. 12, once a core has been selected for a processor operation in action 1201, a determination is made whether the core has reached a threshold of accumulated usage where error detection should be enabled to ensure reliability. If the threshold is reached, in action 1205, the operation is performed by the core with error detection enabled and, in some embodiments, error correction enabled. In one embodiment, the error detection is performed by an error detection module of the core (e.g. blocks 131, 133, and 135) or by a software routine executed on one or more of the cores. If the threshold has not been reached, then in 1207, the processor operation is not performed with error detection enabled.

In some embodiments, the error detection threshold is the lifetime limit of a core. However, in other embodiments, it may be a lower value. Also in some embodiments, error detection will only be performed for operations performed by one or more cores which have exceeded the threshold if the processor operation is one that requires reliability.

Because error detection can consume power as well as take time, enabling it only when the accumulated usage of a core is above a certain threshold can reduce power and improve efficiency when such processes may not be needed.

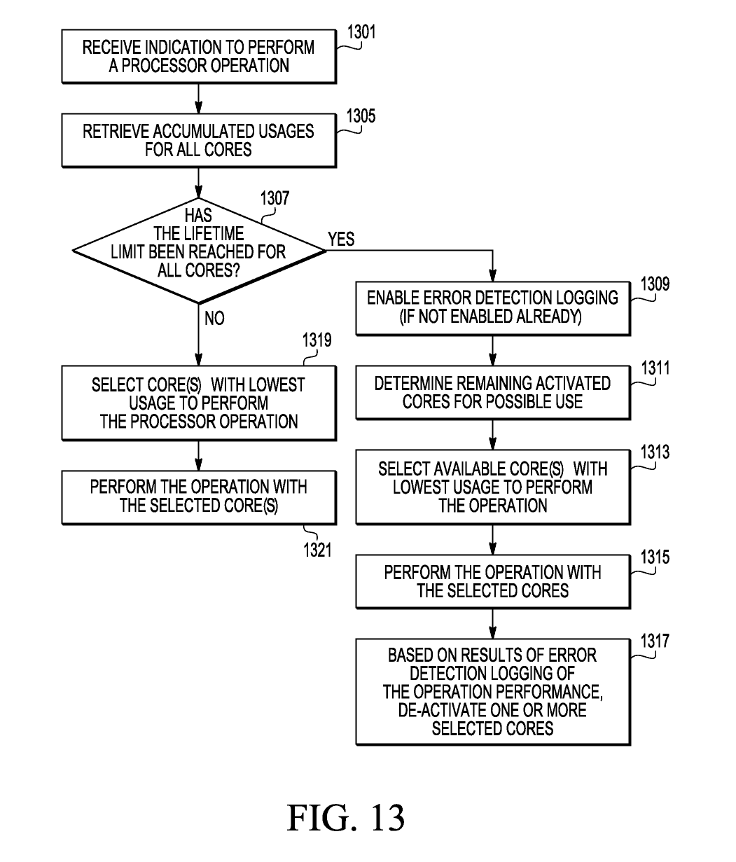

FIG. 13 is a flow diagram showing how error detection logging can be implemented when the accumulated usage of a core has reached a threshold. In one embodiment, error detection logging involves the tracking of detected errors caused by core operations. With the embodiment of FIG. 13, error detection logging is not enabled until the accumulated usage of a core has reached a particular threshold. Once that threshold is met, then error logging is used to determine if a core still performs reliably or whether the core should be removed from operation. Thus, the decision of whether to log errors per core can be made based on accumulated usage. When a part is relatively new, error logging is not needed. Thus, when a system is relatively new and error logging is not needed, not performing error logging increases processor efficiency and reduces power consumption of a data processing system during the early portion of the processor's life.

In action 1301, controller 117 receives an indication of a processor operation to be performed. In action 1305, controller 117 retrieves the accumulated usage information for all cores. In 1307, a determination is made of whether the lifetime limits of all cores have been met. If they have not, then in action 1319, the cores with the lowest accumulated usage are selected to perform the processor operation and the processor operation is performed in action 1321.

If all of the cores have reached their lifetime limit as determined in 1307, then error detection logging is enabled if it has not been enabled previously. In action 1311, controller 117 determines which cores have not been deactivated due to generating excessive errors. In one embodiment, controller accesses a register (not shown) which indicates which cores have been deactivated (or which are still available for use). In 1313, the cores with the lowest usage are selected from the pool of available processors to perform the processor operation, which is performed in action 1315.

In action 1317, the processor operation is checked for errors. Errors may be determined by the execution of a software routine in the operating system to determine if the operation was performed correctly or by other checking methods either implemented by additional hardware or by various software strategies. If an error is detected, it is logged with respect to the core. In one embodiment, controller 117 logs the error in table 151. If the log indicates that the core has generated a specific number of errors, the core is deactivated from use. In some embodiments, logged errors may correspond to correctable or uncorrectable operations, memory or other storage location accesses, or data transference operations which are monitored by error detection logic.

In another embodiment, error detection logging of a particular core may be implemented when a core reaches its lifetime limit or other threshold (e.g. an error detection threshold which may be lower than the lifetime limit in some embodiments). With this embodiment, the decision to implement error logging would be made on an individual core basis and not for all of the cores as a whole. Also, each core may have a different error detection threshold.

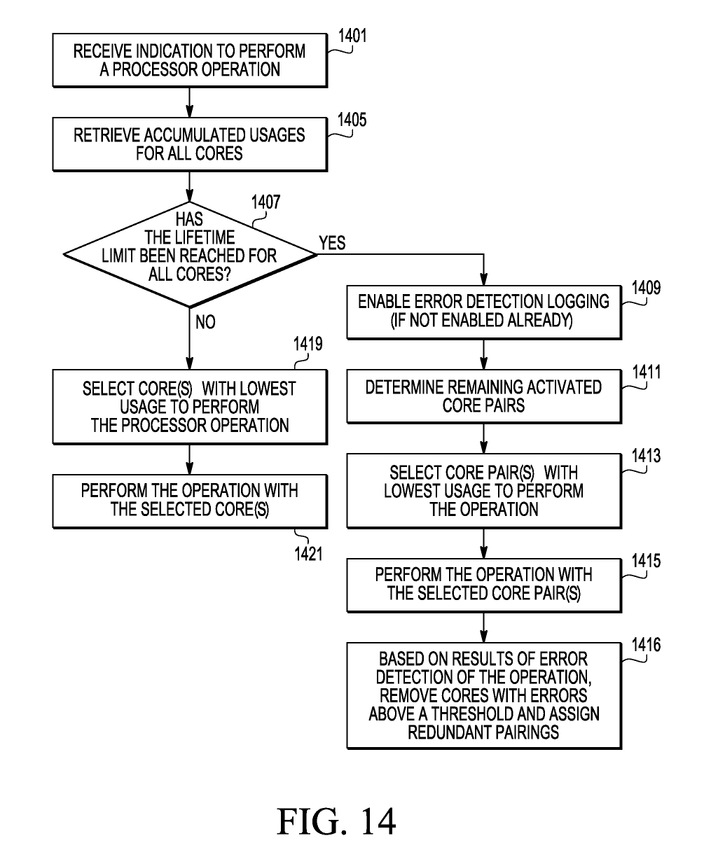

FIG. 14 shows a flow diagram that implements a modification to the process of FIG. 13. In the process of FIG. 14, instead of deactivating a core when the error detection log indicates a specified number of errors, controller 117 will pair the core with one or more cores which have also generated errors over a particular rate and performs operations with those cores redundantly.

In FIG. 14, actions 1401, 1405, 1407, 1409, 1419, and 1421, are similar to actions 1301, 1305, 1307, 1309 1319, and 1321 in the process of FIG. 13. In action 1411, controller 117 determines which of the remaining core pairs are available for use. In one embodiment, a core is paired by indicating a pairing in a register (not shown). In 1413, controller selects which core pair(s) to use for the processor operation based on lowest usage. In other embodiments, core pairs would be selected based on which core pairs have generated the least amount of errors.

After the core pair(s) perform the operation in action 1415, the operation is monitored for errors. If a core committed an error during processing and the error pushed the error count for the core over a particular error threshold, the core is designated (e.g. in a register not shown) as being no longer available for further use in action 1416.

With this embodiment, if the number of errors generated by a core is less than a particular threshold, then that core can still be used in a redundant manner for other operations. Also in action 1416, those single cores that have the measured number of errors under a particular rate are paired together for subsequent redundant use.

In other embodiments, instead of grouping cores into specific pairs at action 1416, the core pairings are made in action 1411 for a particular processor operation. Once the operation is completed by a redundant pair, each core may be reassigned to another core in a subsequent processor operation.

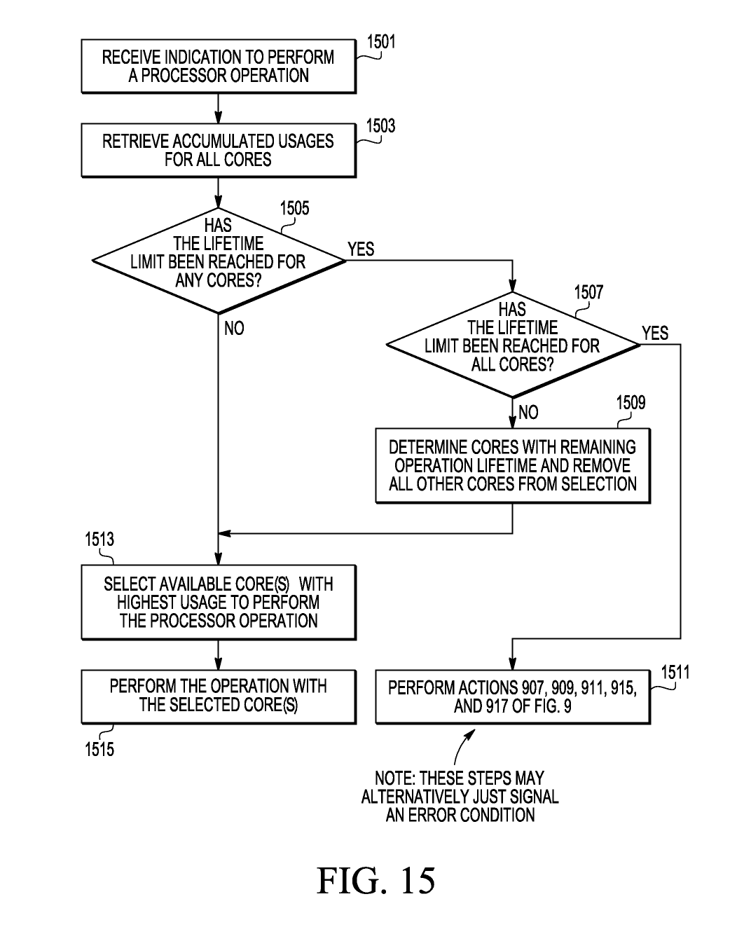

FIG. 15 illustrates a flow process for implementing an embodiment where cores are assigned based on the highest accumulated usage until those cores have met their lifetime limit. With the embodiment of FIG. 15, a few number of cores are “worn-out” early, thereby saving other cores for subsequent use as the processor ages.

In action 1501, controller 117 receives an indication of a processor operation to be performed. In action 1503, controller 117 retrieves the accumulated usage information for all cores. In 1505, a determination is made of whether the lifetime limit of any of the cores has been met. If no core has met their lifetime limit, then in action 1513, the core with the highest accumulated usage is selected to perform the processor operation and the processor operation is performed in action 1515.

If it is determined in 1505 that some cores have reached their lifetime limit and it is determined in 1507 that not all cores have reached their lifetime limit, then in action 1509, those cores that have reached their lifetime limit are removed from the selection pool. In action 1513, the remaining cores (those that have not reached their lifetime limit) with the highest accumulated usage are selected to perform the processor operation, and the processor operation is performed in action 1515.

If in 1507, it is determined that all of the cores have reached their lifetime limit, then the processor operation may be performed redundantly by multiple cores (in action 1511) as described in actions 907, 909, 911, 915, and 917. In some embodiments, an error message regarding the accumulated usage of all cores being past their lifetime limit is generated in place of or in addition to performing the processor operation as described in actions 907, 909, 911, 915, and 917.

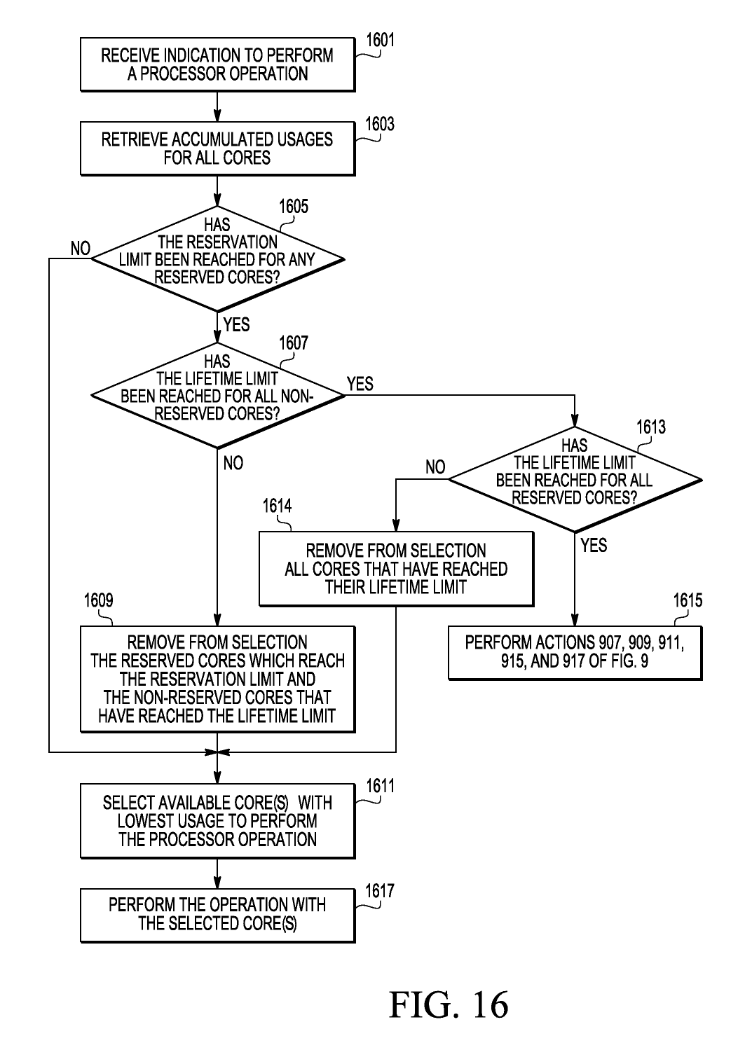

FIG. 16 illustrates a flow process for implementing an embodiment where the system will reserve a number of cores for subsequent use when the accumulated usage of those cores reaches a particular value. The other non-reserved cores are worn out before the reserved cores are used again. With such an embodiment, a subset of cores can be placed in reserve to perform critical operations or operations requiring reliability near the end of the processor's designed lifetime.

In action 1601, controller 117 receives an indication of a processor operation to be performed. In action 1603, controller 117 retrieves the accumulated usage information for all cores. In 1605, a determination is made of whether the reservation limit of any “reserved cores” have been met. In one embodiment, the reservation limit is an accumulation usage value that is below the life time limit of a core. It is an accumulated usage value that the system does not want the core to exceed until all of the lifetime limits of the non-reserved cores has been reached. In some embodiments, the reservation value is an accumulated usage value where the core has a high probability of completing a processor operation without error (or at least at a somewhat lower probably of generating an error than a core near its lifetime limit). In one embodiment, the reservation limit is 40% of the lifetime limit, but maybe of other values in other embodiments. In one example, the number of reserved cores is approximately 20% of the total number of cores, however, that percentage may be different with other embodiments. In one embodiment, the reservation limit for each core is stored in table 123, but may be stored in other locations in other embodiments.

In one embodiment, the reserved cores are preselected (e.g. at integrated circuit manufacture, at system manufacture, or during system programming). In other embodiments, the reserve cores as designated as the cores with the lowest accumulated usage when the core with the highest accumulated usage reaches the reservation limit.

If in 1605, the reservation limit has not been reached for any core, then in action 1611, the core or cores with the lowest accumulated usage are selected to perform the processor operation, where the processor operation is performed in action 1617. If in 1605, some reserved cores have reached their reservation limit, then a determination is made in 1607 of whether the lifetime limit has been reached for all non reserved cores. If not all non-reserved cores have reached their lifetime limit, then in 1609, the reserved cores that have reached their reservation limit and the non reserved cores that have reached their lifetime limit are removed from selection. In action 1611, a core or cores with the lowest accumulated usage are selected from the remaining cores (reserved cores whose usage is below the reservation limit and non-reserved cores whose usage is below the lifetime limit) to perform the processor operation, where the processor operation is performed in 1617.

If in 1607, the lifetime limit has been reached by all non-reserved cores, then a determination is made whether the lifetime limit has been reached for all reserved cores in 1613. If not all reserved cores have reached their lifetime limit, then in action 1614, those cores that have reached their lifetime limit are removed from the selection pool. In action 1611, a core or cores with the lowest accumulated usage are selected from the remaining cores (reserved cores whose usage is below the lifetime limit) to perform the processor operation, where the processor operation is performed in 1617.

If in 1613 it is determined that all cores have reached their lifetime limit, then the processor operation may be performed redundantly by multiple cores in action 1615 as described in actions 907, 909, 911, 915, and 917. In some embodiments, an error message regarding the accumulated usage of all cores being past their lifetime limit is generated in place of or in addition to performing the processor operation redundantly.

It is understood that various features described with respect to some of the embodiments of FIGS. 7-16 may be implemented (including with modifications) with other embodiments of FIGS. 7-16. For example, the error detection features set forth in FIGS. 12, 13, and 14 may be implemented in the embodiments of FIGS. 7, 8, 9, 10, 11, 15, and 16. Furthermore, the reservation feature of FIG. 16 may be implemented in the embodiments of FIGS. 7-15.

Embodiments shown in Figures set embodiments for the allocation of core or cores to perform a processor operation based on accumulated usage. For example, action 1015 allocates cores based on lowest accumulated usage and action 1513 allocates cores based on highest accumulated usage. With some embodiments, core usage may be allocated based on other factors as well such as heat distribution and voltage leveling. Hence, selection of the cores in these actions may be based on lowest usage and on the other factors wherein the actual core selected may not necessarily be the core with the lowest accumulated usage (as in action 1015) or with the highest accumulated usage (as in action 1513). Instead, the core selected may be a core with one of the lowest accumulated usages but whose selection was made over a core with a lower usage to balance the heat load (or other factors) of the processor.

Furthermore, accumulated usage for core may be determined according to other methods. For example, usage of a core may be calculated with a ring oscillator (not shown). Accumulated usage may be monitored by recording the number of instructions executed by a processor core.

In one embodiment, the lifetime limits for each core of a processor may be the same. Also, the reservation limit for each core of a processor may be the same. However, in other embodiments, different cores in a processor may have different lifetime limits from each other e.g. due to their relative locations in the processor, the different types or configurations of the cores, or the different types of operations performed by the cores. Also, the reservation limits for the different reserved cores of a processor may be different as well.

As used herein, a “storage” refers to a memory location. For example, a storage may be a register, RAM, ROM, or a location of a register, RAM, or ROM. In some embodiments, multiple “storages” may be included in one memory device.

In one embodiment of a multi core data processor, a method includes receiving an indication to perform a processor operation and selecting at least one selected processor core of a plurality of processor cores of the data processor to perform the processor operation. The selecting includes using accumulated usage information of at least one of the plurality of processor cores. The accumulated usage information of a processor core is indicative of accumulated usage of the processor core. The method includes performing the processor operation by the at least one selected processor core.

In another embodiment, a data processor includes a plurality of processor cores configured to perform data processing operations and storage for accumulated usage information for each of the processor cores of the plurality of processor cores. The accumulated usage information is indicative of accumulated usage of each processor core of the plurality of processor cores. The data processor includes a controller coupled to the plurality of processor cores and the storage and configured to select one or more selected processor cores from the plurality of processor cores to perform processor operations based on the accumulated usage information.

While particular embodiments of the present invention have been shown and described, it will be recognized to those skilled in the art that, based upon the teachings herein, further changes and modifications may be made without departing from this invention and its broader aspects, and thus, the appended claims are to encompass within their scope all such changes and modifications as are within the true spirit and scope of this invention.

What is claimed is:

1. In a multi core data processor, a method comprising:
receiving an indication to perform a processor operation;
selecting at least one selected processor core of a plurality of processor cores of the data processor to perform the processor operation, wherein the selecting includes using accumulated usage information of at least one of the plurality of processor cores, wherein accumulated usage information of a processor core is indicative of accumulated usage of the processor core; and
performing the processor operation by the at least one selected processor core.

2. The method of claim 1 further comprising:
wherein the selecting includes not selecting cores having an allocated usage that exceeds a lifetime maximum allocated usage of the core.

3. The method of claim 1 further comprising:
when a lifetime maximum allocated usage is determined to have been exceeded by a core of the at least one selected processor core, modifying the operation of the data processor to change an operating condition parameter of the at least one selected processor core.

4. The method of claim 1 further comprising retrieving accumulated usage information of the plurality of processor cores including the at least one selected processor core and using the accumulated usage information retrieved in the selecting.

5. The method of claim 1 wherein:
the selecting the at least one selected processor core further comprises:
selecting the at least one selected processor core from a selection pool of the plurality of processor cores;
if the accumulated usage for each processor core of the plurality of processor cores is greater than or equal to a first threshold of the core, then the selection pool consists of processor cores of the plurality of processor cores that are configurable to perform redundant operations with another processor core of the selection pool;
if the accumulated usage for each processor core of the plurality of processor cores is greater than or equal to the first threshold of the core, the performing the processor operation further comprises configuring a plurality of the selected processor cores for redundant operation for the performing the processor operation.

6. The method of claim 5 further comprising:
after said performing, checking the results of the redundant operation in performing the processor operation to determine if the processor operation was performed correctly.

7. The method of claim 5 wherein if the accumulated usage for any processor core is not greater than or equal to the first threshold of the processor core, the performing the processor operation does not include configuring a plurality of the selected processor cores for redundant operation for the performing the processor operation.

8. The method of claim 5 if the accumulated usage of any processor core of the plurality is not greater than or equal to the first threshold of the processor core, the selection pool does not include any processor core with an accumulated usage greater than or equal to the first threshold of the processor core.

9. The method of claim 1 wherein:
the selecting the at least one selected processor core further comprises selecting the at least one selected processor core from a selection pool of the plurality of processor cores;
the plurality of processor cores includes reserved processor cores and non reserved processor cores;
if the accumulated usage of any processor core of the plurality is not greater than or equal to the first threshold of the core, the selection pool does not include any reserved processor core with an accumulated usage greater than or equal to a second threshold of the reserved processor core and does include any non reserved processor core with an accumulated usage greater than or equal to the first threshold of the non reserved processor core;
wherein the first threshold is greater than the second threshold for the reserved processor cores.

10. The method of claim 1 further comprising:
determining whether the processor operation requires reliability; and
if the processor operation does not require reliability, then the selecting at least one selected processor core further comprises selecting a processor core from a selection pool based on a highest accumulated usage to perform the processor operation.

11. The method of claim 10 wherein:
if the processor operation does require reliability, then said selecting at least one selected processor core further comprises selecting a processor core based on a lowest accumulated usage to perform the processor operation.

12. The method of claim 1 wherein if the accumulated usage for a processor core of the at least one processor core is greater than or equal to an error detection usage threshold of the processor core, the performing includes performing the processor operation with error detection enabled for the processor core.

13. The method of claim 12 wherein if the accumulated usage for a processor core of the at least one processor core is less than the error detection usage threshold of the processor core, error detection is not enabled for the processor core in performing the processor operation.

14. The method of claim 1 further comprising:
if the accumulated usage of a processor core of the at least one selected processor core is greater than or equal to an error detection enabling limit of the processor core, then:
the performing the processor operation includes performing the processor operation with error detection logging enabled for the processor core; and
storing the error detection logging information associated with the processor core in a storage device in response to a change in error detection logging information for the processor core.

15. The method of claim 14 if the accumulated usage of the processor core is not greater than or equal to the error detection enabling limit of the processor core, then the performing the processor operation is performed without error detection logging being enabled for the processor core.

16. The method of claim 14 further comprising:
pairing the processor core to another processor core of the plurality to perform a subsequent processor operation based on the error detection logging information.

17. A data processor comprising:
a plurality of processor cores configured to perform data processing operations;
storage for accumulated usage information for each of the processor cores of the plurality of processor cores, wherein the accumulated usage information is indicative of accumulated usage of each processor core of the plurality of processor cores; and
a controller coupled to the plurality of processor cores and the storage and configured to select one or more selected processor cores from the plurality of processor cores to perform processor operations based on the accumulated usage information.

18. The data processor of claim 17 further comprising:
a second storage for lifetime limit values for each of the plurality of processor cores, wherein the lifetime limit is characterized as a total amount of accumulated usage that a processor core can reliably perform, and
the controller is coupled to the second storage and further configured select one or more selected processor cores from the plurality of processor cores to perform processor operations using the accumulated usage information and the lifetime limit values.

19. The data processor of claim 17 further comprising:
error detection circuitry configured to detect processing errors by the processor cores, and provide error information to the controller; and
the controller is further configured to selectively enable the error detection circuitry to detect a processing error by a processor core of the plurality of processor cores using the accumulated usage information for the processor core.

20. The data processor of claim 17 further comprising:
a second storage for reservation limit values for each of a reservation set of processor cores of the plurality of processor cores, wherein a reservation limit value for an associated processor core of the reservation set is characterized as a threshold amount of accumulated usage for the associated processor core beyond which the associated processor core will not be selected to perform the processor operation unless other processor cores of the plurality of processor cores not of the reservation set exceed an associated lifetime limit; and
the controller is coupled to the second storage and further configured to select one or more selected processor cores from the plurality of processor cores to perform processor operations based on the accumulated usage information and the reservation limit values.
